(19) United States
(12) Patent Application Publication
(10) Pub. No.: US 2013/0101146 A1
(43) Pub. Date: Apr. 25, 2013

(54) COMPACT STEREO LOUDSPEAKER FOR WALL MOUNTING

(71) Applicant: Jes Mosgaard, Silkeborg (DK)

(72) Inventor: Jes Mosgaard, Silkeborg (DK)

(73) Assignee: LIBRATONE A/S, Skovlunde (DK)

(21) Appl. No.: 13/702,234

(22) PCT Filed: Jun. 7, 2010
(86) PCT No.: PCT/DK2010/050126

§ 371 Date: Jan. 7, 2013

(51) Int. Cl. H04R 5/02

(52) U.S. Cl. CPC H04R 5/02
USPC 381/300

(57) ABSTRACT

Loudspeaker in a single cabinet arranged for wall mounting. The loudspeaker has two dipole loudspeaker units spaced apart and arranged to generate respective acoustic dipole signals. Reflectors, such as plane surfaces, are arranged to reflect sound from the respective dipole loudspeaker units. The reflectors and the dipole loudspeaker units are arranged such in relation to the cabinet that sound from one side of their diaphragms is directed substantially parallel with the wall and away from the cabinet, preferably to the sides. Sound from the opposite side of the diaphragms is directed substantially perpendicular to the wall and away from the wall. Such loudspeaker is suited in versions as a stereo sound bar, e.g. placed under a flat screen TV set. The loudspeaker provides a wide stereo image which can be experienced in a large area in a normal room due to reflections from side walls, and still the loudspeaker produced a stable centre image. The dipole units may be implemented as two-way systems, and a centrally placed woofer may be included to reproduce low frequency audio components in mono.

### FIELD OF THE INVENTION

The invention relates to the field of audio equipment, especially to the field of audio loudspeakers, more specifically the invention provides a one-cabinet stereo loudspeaker arranged for wall mounting.

### BACKGROUND OF THE INVENTION

Compact stereo reproducing equipment with a pair of closely spaced stereo loudspeakers and matching amplifiers in one single cabinet are popular ways of playing stereo sound. Often such systems include docking station capabilities for portable MP3 players and/or CD players.

To enhance the stereo effect, i.e. the impression of a wide sound image, in spite of a small physical distance between loudspeakers, a large variety of signal processing manipulations are known to provide some effects, but either such manipulations tend to decrease other parameters of the overall sound quality, e.g. the timbre, and still the effect is only present when the listener is placed between the stereo loudspeakers.

For portable equipment it can be tolerated that the stereo system must be moved to bring the listener in the correct position for an acceptable stereo effect, but for stationary equipment, e.g. equipment mounted on a wall, or systems with large and heavy loudspeakers, the desired spacious stereo effect can only be obtained in a limited listening position area around the best position the “sweet spot”. For a stereo set of loudspeakers placed in a large living room this means that a stereo image can typically only be obtained in one seating group, while in other areas of the living room the stereo loudspeakers act more or less as a mono sound source without any spacious sound image.

### SUMMARY OF THE INVENTION

In view of the above, it may be seen as an object of the present invention to provide a compact stereo loudspeaker system which is capable of providing a spacious sound reproduction of a stereo signal in a large area, i.e. also for listening positions outside the area between the stereo loudspeakers.

The invention provides a loudspeaker arranged for mounting on or adjacent to a wall, the loudspeaker being arranged to receive an input signal with first and second channels and to generate respective first and second acoustic signals accordingly, the loudspeaker device having a cabinet comprising
a set of first and second dipole loudspeaker units arranged to generate respective first and second acoustic dipole signals, the first and second dipole loudspeakers being spaced apart, and
a set of first and second reflectors, such as plane surfaces, arranged to reflect sound from the respective first and second dipole loudspeaker units, wherein the first and second dipole loudspeaker units are arranged in relation to the cabinet and to the reflectors such that sound from one side of their diaphragms is directed substantially parallel with the wall and away from the cabinet, and sound from the opposite side of their diaphragms is directed substantially perpendicular to the wall and away from the wall.

Such stereo loudspeaker is advantageous since it provides a combination of a traditional stereo set of loudspeakers, i.e. the sound from the two loudspeaker units which is radiated perpendicular to the wall and away from the wall mid-range of full-range loudspeaker unit, and sound radiated along the back wall on which the loudspeaker is mounted. This portion of the sound from the loudspeaker will partly be diffracted by the back wall, and the remaining part of this sound will be reflected by side walls or other acoustically reflecting objects. Thus, the sound part radiated perpendicular to the wall on which the loudspeaker is mounted or placed, will help to create a spacious sound image in a large area, since the two stereo loudspeakers preferably radiate their respective portions in opposite directions. The effect is that this part of the sound, when reaching the listener, will arrive to the listener from directions outside the physical dimensions of the loudspeaker, namely from side walls or other reflecting objects. This will provide a spacious stereo image which can be enjoyed in a large area, such as in most parts of a living room, unless of course the loudspeaker is placed close to a corner or the like. In a typical position on a wall in a typical living room the stereo image created by the loudspeaker will be 1-2 m wider than the dimensions of the loudspeaker. Still, for preferred sizes of the loudspeaker, i.e. with the two loudspeaker units spaced apart by less than 1 m, such as spaced apart by a distance of 0.3-0.8 m, the loudspeaker will create a stable centre image due to the direct sound from the loudspeaker units radiated perpendicular to the back wall on which it is mounted.

As will also be seen in the following, the loudspeaker can be implemented with a very limited depth even with the use of standard loudspeaker units, and thus the loudspeaker is highly suited to match the width and depth of a typical flat screen TV set and can be wall mounted just below such TV set to reproduce TV stereo sound or form the centre/stereo part of a surround system, e.g. with yet another loudspeaker according to the invention used as a back set of stereo loudspeakers. A limited depth is generally an important parameter which enables various designs of the loudspeaker allowing it to fit on a wall or on a table of book shelf or the like adjacent to a wall in an unobtrusive way in a normal home.

By ‘reflector’ is understood a physical structure with acoustically reflecting properties in a given frequency range, i.e. with a shape and a dimension and with an acoustical absorption coefficient of less than 0.5 in the given frequency range e.g. 200 Hz to 20 kHz or only the range 500 Hz to 5 kHz. Preferably, however the reflector provides an acoustical absorption coefficient of less than 0.4, such as less than 0.3, such as less than 0.2, such as less than 0.1, in the given frequency range, thus serving to direct practically all acoustic energy away from the loudspeaker and thus provide a high electro-acoustic efficiency.

As ‘dipole loudspeaker unit’ a normal standard loudspeaker units such as cone based electro-dynamic loudspeaker can be used, since such units are inherently acoustic dipoles. However, it is to be understood that a dipole can also be implemented as two separate loudspeaker units, e.g. two dome tweeters with flat magnets mounted back to back, since such configuration will, at least up to a certain frequency, act as an acoustic dipole when electrically connected in opposite phase. As dipole loudspeaker unit at high frequencies an air motion transformer unit is preferred, however other types of ribbon based units such as electrostatic or electrodynamic types may be used.

By ‘cabinet’ is understood to include at least a structure serving to hold the two loudspeaker units and the two reflectors in the desired position relative to each other, thus underlining that one single loudspeaker cabinet includes loudspeaker units capable of reproducing a stereo image, namely the first dipole unit playing left channel and the second dipole unit playing right channel of the input signal. The cabinet is not necessarily a box since in simple embodiments only two dipole loudspeaker units are required to implement the loudspeaker, and these units should be placed such that both sides of their diaphragms look into openings to the environment.

Since most normal loudspeaker units are inherently dipoles, the resulting electrical to acoustic efficiency of the loudspeaker will be high because the reflectors direct all acoustic energy away from the loudspeaker without acoustic energy being wasted in absorbing material.

Furthermore, the fact that the loudspeaker is designed specifically for mounting on or positioning adjacent to a back wall means that its acoustical environment is predictable and thus easy to take into account in the spectral equalizing of the loudspeaker. This means that with one equalizing of a loudspeaker model, all consumers will experience substantially the same spectral performance. In contrast, normal hi-fi loudspeaker boxes are placed in very different ways, from an acoustic point of view, thus providing an unpredictable spectral performance for each individual consumer.

In preferred embodiments, the first dipole loudspeaker unit is placed in left side of the cabinet and the second dipole loudspeaker unit is placed in the right side of the cabinet, and wherein the first and second dipole loudspeaker units are arranged such in relation to the respective reflectors that sound from one side of the diaphragm of the first dipole loudspeaker unit is directed substantially parallel with the wall and towards the left side, and sound from one side of the diaphragm of the second dipole loudspeaker unit is directed substantially parallel with the wall and towards the right side. Hereby an extended stereo image with a width wider than the distance between the loudspeaker units is obtained.

Preferably, the first and second dipole loudspeaker units are arranged in the cabinet with their main axis of sound radiation being substantially perpendicular to the wall. Especially, the first and second dipole loudspeaker units may be arranged with their diaphragms extending in a plane parallel with a front panel of the cabinet, such as mounted in respective openings of the front panel of the cabinet such that sound from front sides of their respective diaphragms radiate sound perpendicular to the wall and away from the wall. Thus, especially the first and second reflectors are arranged adjacent to the respective first and second dipole loudspeaker units and angled such that they direct sound from back sides of their respective diaphragms substantially parallel with the wall. Hereby even a mid range or full range driver with a rather large diaphragm area can be housed in the cabinet requiring only a limited depth of the cabinet. Alternatively, the first and second dipole loudspeaker units may also be arranged in the cabinet with their main axis of sound radiation being substantially parallel to the wall and in relation to the reflectors such that the reflectors direct sound away from the dipole loudspeaker units and perpendicular to the wall.

The first and second reflectors comprise substantially vertical plane surfaces angled 20-70° in relation to the wall, such as 30-60° in relation to the wall, such as 40-50° in relation to the wall. Especially, the first and second reflectors are implemented as substantially vertical plane surfaces angled substantially 45° in relation to the wall. The reflector may be implemented as a single plane plate of a metal, a wooden material, a polymeric material or the like provided that the acoustical absorption coefficient is below 0.5, preferably lower. Preferably, the first and second reflectors are placed adjacent to the edge of the respective first and second dipole loudspeaker units so as to ensure that substantially all sound energy radiated by one side of the dipole loudspeaker unit is reflected.

A preferred embodiment comprises a second set of first and second dipole loudspeaker units arranged to generate respective third and fourth signals accordingly, wherein the second set of dipole loudspeaker units are arranged in relation to the cabinet and to the reflectors such that sound from one side of their diaphragms is directed substantially parallel with the wall and away from the cabinet, and sound from the opposite side of their diaphragms is directed substantially perpendicular to the wall and away from the wall. With such two-way system, both treble and mid range can be effectively reflected perpendicular and parallel with the back wall and thus provide the described stereo image effect in the most essential part of the audio frequency range. Especially, the loudspeaker may comprise a dividing network, such as a digital dividing network, arranged to split the input signal into a higher frequency band which is applied to the first set of dipole loudspeaker units and into a lower frequency band which is applied to the second set of dipole loudspeaker units. Especially, the first and second set of loudspeaker units may each have a reflector placed close to the unit so as to reflect sound from the loudspeaker unit, i.e. one reflector for each loudspeaker unit. In practice such reflectors may have the same angle but displaced such that the reflector is very close to each loudspeaker diaphragm.

A preferred embodiment comprises a loudspeaker unit arranged to generate an acoustic signal below a lower cut-off frequency of the input signal, such as a single loudspeaker unit arranged in the cabinet between the first and second dipole loudspeaker units and applied with a combined mono signal based on the input signal below the lower cut-off frequency. One such low frequency loudspeaker unit is preferably positioned in the cabinet between the first and second dipole loudspeaker units. The low frequency loudspeaker unit can be placed in a closed or vented part of the cabinet.

Preferably, the loudspeaker comprises a filter arranged to spectrally equalize the acoustic response of the loudspeaker to a target response for the situation where the loudspeaker is placed on a wall.

The loudspeaker is preferably arranged to receive the input signal in a digital format, such as in a wireless digital format. The loudspeaker is preferably suited for streaming of sound from an iPhone, an iPod Touch or the like, and further to receive an input signal from a TV set or a set-top box.

The loudspeaker preferably comprises amplifiers arranged to amplify the input signal and to apply the respective amplified signals to the first and second dipole loudspeaker units, preferably the loudspeaker comprises separate amplifiers to all loudspeaker units included so as to provide a fully active loudspeaker.

In a second aspect, the invention provides a method for playing an input signal with first and second channels to respective first and second acoustic signals accordingly, the method comprising
arranging a set of first and second dipole loudspeaker units spaced apart in a cabinet,
arranging first and second reflectors so as to reflect sound from the respective first and second dipole loudspeaker units,
   wherein the first and second dipole loudspeaker units are arranged in relation to the cabinet and to the reflectors such that sound from one side of their diaphragms is directed substantially parallel with the wall and away from the cabinet, and sound from the opposite side of their diaphragms is directed substantially perpendicular to the wall and away from the wall.

It is appreciated that equivalent embodiments and advantages mentioned for the first aspect apply as well for the second aspect.

It is appreciated that two or more of the mentioned embodiments can advantageously be combined.

### BRIEF DESCRIPTION OF THE DRAWINGS

Embodiments of the invention will be described, by way of example only, with reference to the drawings, in which

FIG. 1 illustrates a sketch of an embodiment where the reflector is used behind the dipole loudspeaker unit to direct parallel with the back wall,

FIG. 2 illustrates a sketch of another embodiment where the dipole loudspeaker units are turned 90° compared to FIG. 1, and where the reflector is thus used to provide the sound radiated perpendicular to the back wall,

FIG. 3 illustrates a preferred embodiment with a central woofer unit and with direct and reflected sound from the dipole units are indicated with arrows,

FIG. 4 illustrates for a preferred embodiment a listener positioned right in from of the loudspeaker and how the various sound contributions from one of the dipole units serve to create a phantom source outside the physical dimensions of the loudspeaker,

FIG. 5 shows for a prior art normal set of separate stereo loudspeakers the position of a centre image phantom source which the listener will experience in two listening positions,

FIG. 6 shows for a loudspeaker according to the invention a corresponding position of a centre image phantom source in two listening positions,

FIG. 7 shows a drawing of a preferred embodiment with a central woofer in a closed cabinet and where the stereo dipoles each include a tweeter unit and a mid range unit operating in respective frequency ranges.

### DESCRIPTION OF EMBODIMENTS

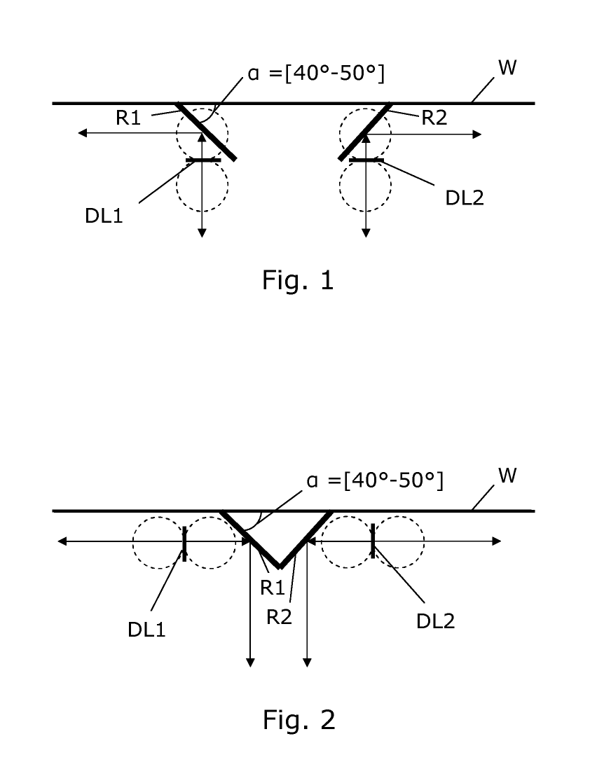

FIG. 1 shows a principle sketch of a simple embodiment where the first and second dipole loudspeaker units DL1, DL2 (with their dipole radiation patterns indicated with dashed circles) are placed spaced apart and with their diaphragms parallel with the back wall W and with respective reflectors R1, R2 placed adjacent to the diaphragms of the units DL1, DL2. Front sides of the diaphragms of the units DL1, DL2 generate sound perpendicular to the wall W, and thus directly towards the listener. Via the respective reflectors R1, R2, here illustrated as plane plates, back sides of the unit's diaphragms serve to direct sound parallel with the wall W. The reflectors R1, R2 preferably have the major part of their reflecting surfaces angled 40°-50°, most preferably around 45°, in relation to the wall W, as illustrated, such that sound from the back sides of the diaphragms are directed parallel with the wall W to the opposite sides.

When left and right channels of a stereo audio signal is applied to the respective units DL1, DL2, a wide stereo image can be experienced over a large area in a normal room due to the sound portions reflected in opposite directions parallel with the back wall W. These reflected portions will be reflected by opposite side walls of the room and thus arrive to the listener serving to widen the stereo image created by the direct sound from the units DL1, DL2.

FIG. 2 shows a principle sketch of an alternative embodiment where the dipole loudspeaker units DL1, DL2 are turned 90° compared to the embodiment of FIG. 1, and thus the units DL1, DL2 are arranged with their diaphragms perpendicular to the wall W. The reflectors R1, R2 here serve to reflect sound from back sides of the diaphragms and direct it perpendicular to the wall and thus form the direct sound towards the listener, while the front sides of the units DL1, DL2 radiate sound parallel with the wall W.

Still other configurations of the dipole loudspeaker units DL1, DL2 may be implemented, e.g. using reflectors on both sides of the units DL1, DL2 to respectively direct sound perpendicular to the wall W and parallel with the wall W.

For simplicity the cabinet is not shown in FIGS. 1 and 2, however as mentioned in simple embodiments the only cabinet structure required is a structure holding the two loudspeaker units DL1, DL2 and the two reflectors R1, R2 in position together. However, the cabinet preferably includes a front panel or baffle with the required openings.

In yet another embodiment, not shown, the two loudspeaker units are angled 45° in relation to the wall, while two reflectors are arranged to radiate sound away from respective diaphram sides of the loudspeaker units: a first reflector serves to radiate sound from one diaphragm side perpendicular to the wall, while a second reflector serves to radiate sound from the opposite diaphragm side substantially perpendicular to the wall. Thus, in such embodiment all sound from the loudspeaker is reflected sound from the loudspeaker units.

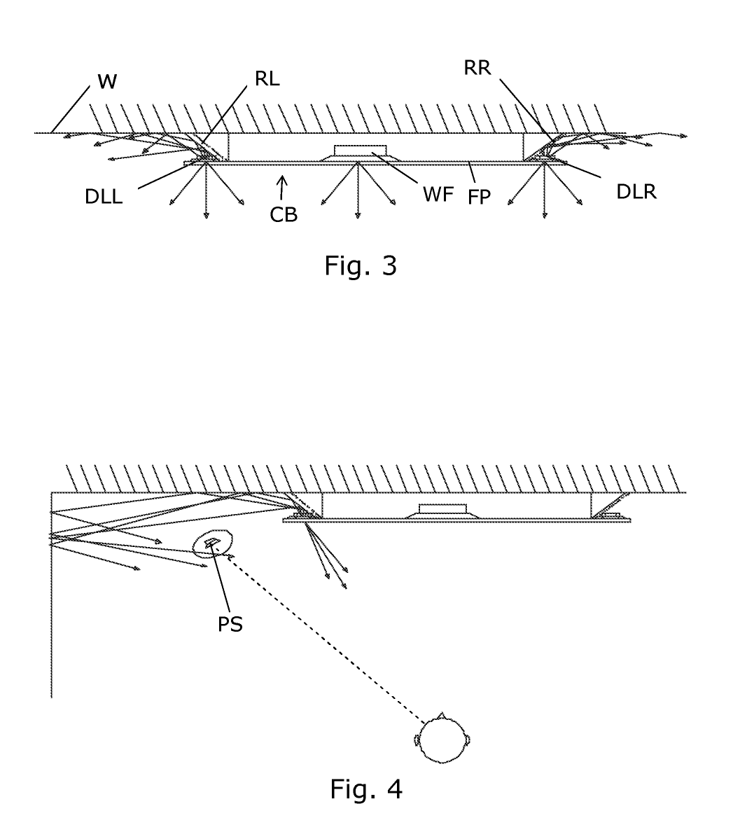

FIG. 3 shows a preferred loudspeaker embodiment mounted on a wall W with a configuration of the dipole loudspeaker units DLL, DLR similar to that sketched in FIG. 1. Left and right dipole loudspeaker units DLL, DLR are mounted in each side of a plane front panel FP and in front of respective reflecting plates RF, RR placed behind the loudspeaker units DLL, DLR and angled 45° in relation to the wall W but in opposite directions so as to direct sound from back sides of the diaphragms of the units DLL, DLR parallel with the wall W and away from the loudspeaker. Arrows serve to illustrate sound waves from the units DLL, DLR, both the direct sound from the diaphragms in the direction perpendicular to the wall W and direct towards a normal listening position in front of the loudspeaker, and also the reflected sound to the sides which is partly diffracted by the back wall W. The cabinet CB includes a closed or vented box formed partly by the front panel FL. A low frequency woofer WF is placed which plays the stereo audio signals in mono below a predetermined cut-off frequency.

FIG. 4 shows the loudspeaker embodiment of FIG. 3 placed on a wall in a room. Arrows indicate sound from the left dipole loudspeaker unit to a listener placed right in front of the loudspeaker. As seen, the direct sound and the sound portion reflected by the nearest side wall reaches the listener. Due to the psychoacoustic principle of summation, the listener will perceive the sound as coming from one single “phantom source” PS if all sound waves arrive to the listener within a short period of time. The perceived direction to the phantom source PS is determined by the directions of the incoming sound waves, their mutual intensities and their arrival times. In the sketched configuration, the direct sound and the reflected sound from the loudspeaker will result in a phantom source PS placed to the left of the actual position of the loudspeaker. Thus, the listener will experience sound from the left unit to come from the direction indicated by the dashed line. When reproducing a stereo signal this means that the listener will experience a stereo image being wider than the physical extension of the loudspeaker.

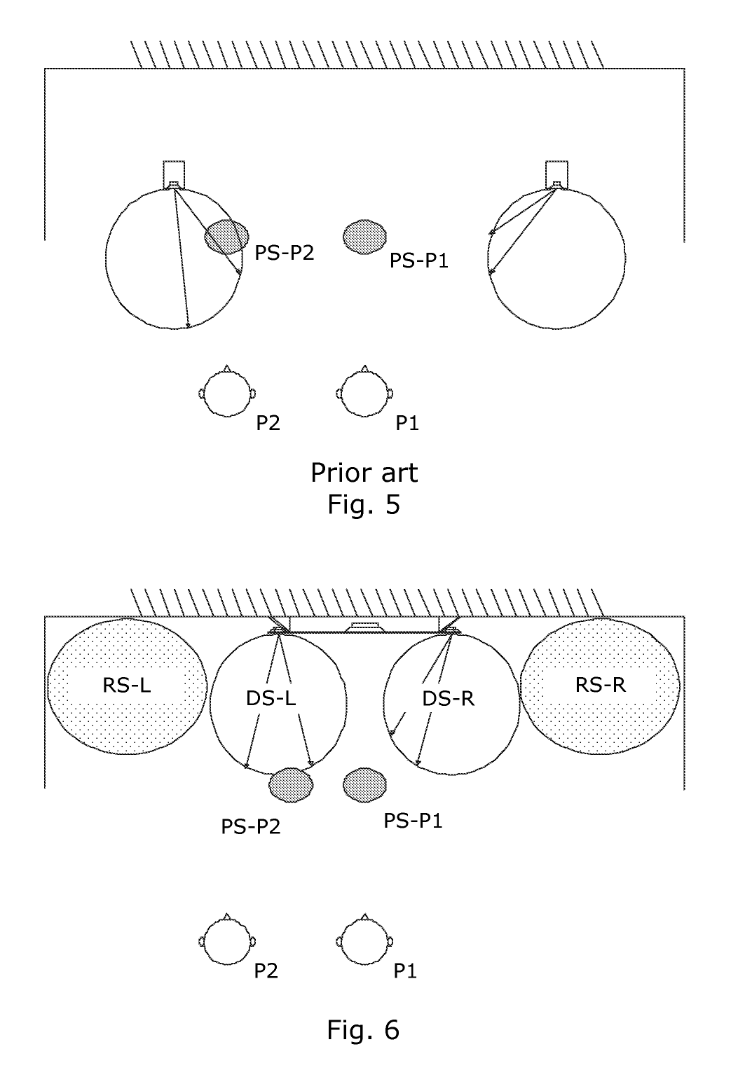

FIG. 5 shows a sketch of a prior art stereo listening setup, i.e. a normal stereo loudspeaker setup with two separate loudspeakers, such as spaced around +/−30° when viewed from the listening position right between the loudspeakers and in an appropriate distance. A listener is shown in two positions: P1 in the normal listening position in the centre between the left and right loudspeaker, and P2 which is laterally displaced and closer to the left loudspeaker. The length of the arrows from the loudspeakers towards the listener positions P1, P2 indicate the intensity of sound waves in these directions, assuming a normal sound directivity pattern for the loudspeakers. Thus, from these arrow lengths it is seen that the relative intensity between sound from left and right loudspeaker changes when moving from P1 to P2.

The dark spots PS-P1 and PS-P2 indicate a phantom source experienced by the listener in the two positions P1, P2 for the situation where the two loudspeakers reproduce a stereo signal where the true sound source is placed in the centre. As seen, this centre image is correctly reproduced for position P1, which is due to the equal intensity from both loudspeakers and the fact that sound from both loudspeakers arrive at the listener at the same time. However, the “centre image” is seen to follow the listener position in P2 to the left, which is caused by the intensity being higher from the left loudspeaker, and sound from the left loudspeaker arrives to P2 before sound from the right loudspeaker. Thus, such loudspeaker setup does not provide a stable centre image when the listener moves around.

FIG. 6 shows a corresponding sketch of a listening setup in a room with the loudspeaker embodiment of FIG. 3 placed on the back wall. DS-L, DS-R indicate the direct sound radiated from respective left and right dipole loudspeaker units perpendicular to the wall and towards the listener, while the dotted areas show sound portions reflected from the side walls and thus also contributing to creating the phantom sources PS-P1 and PS-P2 for the two listener positions P1, P2. As in FIG. 5 arrow length indicate the intensity of direct sound from the loudspeaker units towards the two positions P1, P2. Again, a correct centre image is reproduced for position P1 due to equal intensities and zero arrival time difference. In position P2, the listener is laterally moved beyond the left loudspeaker unit of the loudspeaker, and the reproduced centre image will thus also be moved towards the left, but still towards the centre of the loudspeaker. This is due to the less pronounced intensity difference of the direct sound, as well as a less significant arrival time difference between left and right, compared to the prior art loudspeaker setup of FIG. 5. Thus, it can be concluded that the loudspeaker according to the invention produces a more stable centre image than a conventional stereo loudspeaker setup. This result holds in practical listening tests with prototypes of the loudspeaker where a wide stereo image which can be experienced in a large area in a room is still combined with a rather stable centre image.

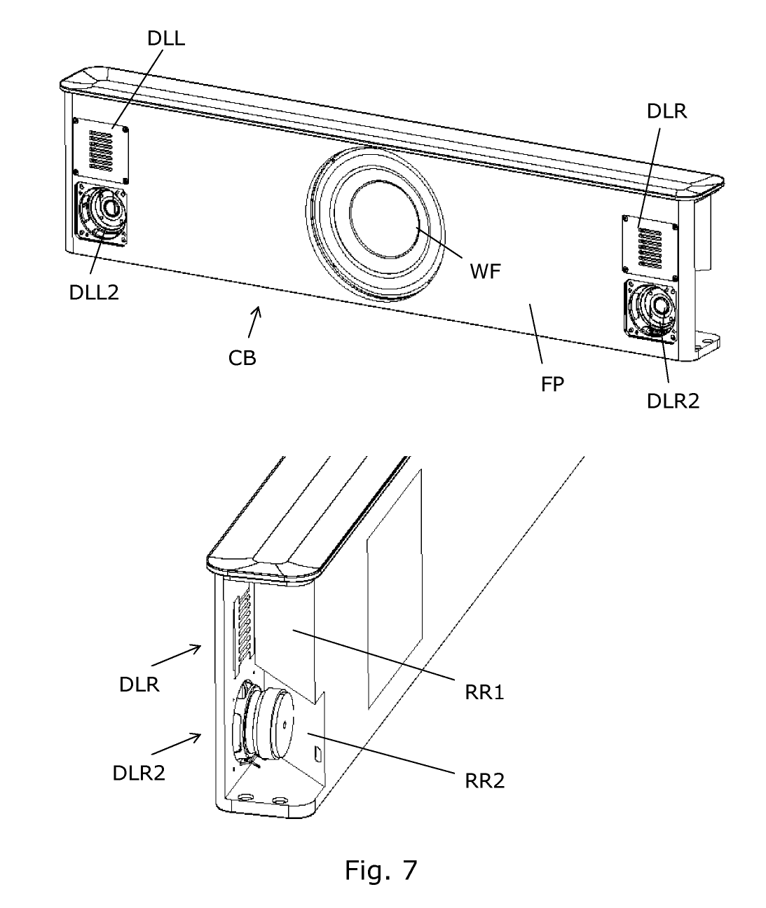

FIG. 7 shows two 3D views of a preferred embodiment with outer dimensions of a flat bar having a width serving to fit a width of a flat screen TV set, thereby creating an aesthetic unit under a wall mounted TV set. In the illustrated version, two-way dipole loudspeakers are used: an air motion transformer tweeter DLL, DLR, and a conventional cone diaphragm mid range unit DLL2, DLR2. A mono woofer WF is placed in an enclosure in the centre of the cabinet CB. All loudspeaker units DLL, DLL2, DLR, DLR2, WF are mounted in the front panel FP. The shown embodiment has a distance between the left and right loudspeaker units of about 95 cm and the depth of the cabinet CB is about 10 cm

In lower part of FIG. 7 the reflector arrangement in the right side of the loudspeaker is visible, and here it is seen that the tweeter DLR and mid range units DLR2 have individual reflectors RR1, RR2. These reflectors RR1, RR2 are both angled to provide an angle of approximately 45° but displaced so as to ensure that the reflector surfaces RR1, RR2 are close to the diaphragms of the respective loudspeaker units DLR, DLR2.

To sum up, the invention provides a stereo loudspeaker in a single cabinet arranged for wall mounting. The loudspeaker has two dipole loudspeaker units spaced apart and arranged to generate respective acoustic dipole signals. Reflectors, such as plane surfaces, are arranged to reflect sound from the respective dipole loudspeaker units. The reflectors and the dipole loudspeaker units are arranged such in relation to the cabinet that sound from one side of their diaphragms is directed substantially parallel with the wall and away from the cabinet, preferably to the sides. Sound from the opposite side of the diaphragms is directed substantially perpendicular to the wall and away from the wall. Such loudspeaker is suited in versions as a stereo sound bar, e.g. placed under a flat screen TV set, and it provides a wide stereo image which can be experienced in a large area in a normal room due to reflections from side walls, and still the loudspeaker produced a stable centre image. The dipole units may be implemented as two-way systems, and a centrally placed woofer may be included to reproduce low frequency audio components in mono.

Although the present invention has been described in connection with preferred embodiments, it is not intended to be limited to the specific form set forth herein. Rather, the scope of the present invention is limited only by the accompanying claims.

In this section, certain specific details of the disclosed embodiments are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Reference signs are included in the claims however the inclusion of the reference signs is only for clarity reasons and should not be construed as limiting the scope of the claims.

1. A loudspeaker arranged for mounting on or adjacent to a wall, the loudspeaker being arranged to receive an input signal with first and second channels and to generate respective first and second acoustic signals accordingly, the loudspeaker having a cabinet comprising:
a set of first and second dipole loudspeaker units arranged to generate respective first and second acoustic dipole signals, the first and second dipole loudspeakers being spaced apart, and
a set of first and second reflectors, arranged to reflect sound from the respective first and second dipole loudspeaker units,
wherein the first and second dipole loudspeaker units are arranged in relation to the cabinet and to the reflectors such that sound from one side of their diaphragms is directed substantially parallel with the wall and away from the cabinet, and sound from the opposite side of their diaphragms is directed substantially perpendicular to the wall and away from the wall, wherein the first and second dipole loudspeaker units are mounted in each side of a plane front panel of the cabinet.

2-15. (canceled)

16. The loudspeaker according to claim 1, wherein the first dipole loudspeaker unit is placed in the left side of the cabinet and the second dipole loudspeaker unit is placed in the right side of the cabinet, and wherein the first and second dipole loudspeaker units are arranged in relation to the respective reflectors such that sound from one side of the diaphragm of the first dipole loudspeaker unit is directed substantially parallel with the wall and towards the left side, and sound from one side of the diaphragm of the second dipole loudspeaker unit is directed substantially parallel with the wall and towards the right side.

17. The loudspeaker according to claim 1, wherein the first and second dipole loudspeaker units are arranged in the cabinet with their main axis of sound radiation being substantially perpendicular to the wall.

18. The loudspeaker according to claim 17, wherein the first and second reflectors are arranged adjacent to the respective first and second dipole loudspeaker units and angled such that they direct sound from back sides of their respective diaphragms substantially parallel with the wall.

19. The loudspeaker according to claim 18, wherein the first and second dipole loudspeaker units are arranged with their diaphragms extending in a plane parallel with a front panel of the cabinet such that sound from front sides of their respective diaphragms radiate sound perpendicular to the wall and away from the wall.

20. The loudspeaker according to claim 19, wherein the first and second reflectors comprise substantially vertical plane surfaces angled 20-70° in relation to the wall.

21. The loudspeaker according to claim 20, wherein the first and second reflectors are implemented as substantially vertical plane surfaces angled substantially 45° in relation to the wall.

22. The loudspeaker according to claim 1, wherein the first and second reflectors are placed adjacent to the edge of the respective first and second dipole loudspeaker units so as to ensure that substantially all sound energy radiated by one side of the dipole loudspeaker unit is reflected.

23. The loudspeaker according to claim 1, comprising a second set of first and second dipole loudspeaker units arranged to generate respective third and fourth signals accordingly, wherein the second set of dipole loudspeaker units are arranged in relation to the cabinet and to the reflectors such that sound from one side of their diaphragms is directed substantially parallel with the wall and away from the cabinet, and sound from the opposite side of their diaphragms is directed substantially perpendicular to the wall and away from the wall.

24. The loudspeaker according to claim 23, comprising a dividing network, arranged to split the input signal into a higher frequency band, which is applied to the first set of dipole loudspeaker units and into a lower frequency band, which is applied to the second set of dipole loudspeaker units.

25. The loudspeaker according to claim 1, wherein the loudspeaker is arranged to generate an acoustic signal below a lower cut-off frequency of the input signal.

26. The loudspeaker according to claim 1, comprising a filter arranged to spectrally equalize the acoustic response of the loudspeaker to a target response for the situation where the loudspeaker is placed on a wall.

27. The loudspeaker according to claim 1, wherein the loudspeaker is arranged to receive the input signal in a digital format.

28. The loudspeaker according to claim 1, comprising amplifiers arranged to amplify the input signal and to apply the respective amplified signals to the first and second dipole loudspeaker units.

29. A method of playing an input signal with first and second channels to respective first and second acoustic signals accordingly, the method comprising:
arranging a set of first and second dipole loudspeaker units spaced apart in a plane front panel of a cabinet, and
arranging first and second reflectors so as to reflect sound from the respective first and second dipole loudspeaker units,
wherein the first and second dipole loudspeaker units are arranged in relation to the cabinet and to the reflectors such that sound from one side of their diaphragms is directed substantially parallel with the wall and away from the cabinet, and sound from the opposite side of their diaphragms is directed substantially perpendicular to the wall and away from the wall.
